(19) United States
(12) Patent Application Publication
(10) Pub. No.: US 2025/0370492 A1
(43) Pub. Date: Dec. 4, 2025

(54) MAXIMUM POWER POINT TRACKING SYSTEM AND OPERATING METHOD THEREOF

(71) Applicant: ELECTRONICS AND TELECOMMUNICATIONS RESEARCH INSTITUTE, Daejeon (KR)

(72) Inventor: Jong Pil IM, Daejeon (KR)

(21) Appl. No.: 19/055,865

(22) Filed: Feb. 18, 2025

(30) Foreign Application Priority Data
May 29, 2024 (KR) 10-2024-0069900

(51) Int. Cl. G05F 1/67; H02J 50/00; H02M 3/158

(52) U.S. Cl. CPC G05F 1/67; H02J 50/001; H02M 3/158

(57) ABSTRACT

Disclosed is a maximum power point tracking (MPPT) system, including an energy harvesting element, a switching circuit sampling an open circuit voltage of the energy harvesting element as a sampling voltage in an open state, receiving an input voltage from the energy harvesting element, and adjusting the input voltage based on the sampling voltage in a short circuit state, a converter circuit converting the adjusted input voltage into an output voltage, and an MPPT control circuit outputting first and second MPPT control signals for controlling the MPPT system to the converter circuit. The first and second MPPT control signals are based on a clock signal and have logic values inverted from each other, and the converter circuit opens or short-circuits the switching circuit based on the first and second MPPT control signal.

### CROSS-REFERENCE TO RELATED APPLICATION(S)

This application claims priority under 35 U.S.C. § 119 to Korean Patent Application No. 10-2024-0069900 filed on May 29, 2024, in the Korean Intellectual Property Office, the disclosures of which are incorporated by reference herein in their entireties.

### BACKGROUND

### 1. Field of the Invention

Embodiments of the present disclosure described herein relate to a system for tracking a maximum power point, and more particularly, relate to a maximum power point tracking (MPPT) system having improved performance and improved efficiency and an operating method of the maximum power point tracking system.

### 2. Description of Related Art

Energy harvesting elements may harvest energy that is wasted in the surrounding environment and convert the harvested energy into electrical energy. The electrical energy generated by the energy harvesting element is transmitted to a power management integrated circuit (PMIC). The power management integrated circuit may convert the electrical energy and may supply the converted electrical energy to a battery or a load.

A maximum power point tracking (MPPT) technology may be a technology that satisfies the condition for transferring the maximum power from an energy harvesting element to a load. A typical maximum power point tracking system may include an open control switch for opening a circuit while sampling the open circuit voltage of the energy harvesting element. The open control switch device is a passive device and may generate power loss in the process of transferring the electrical energy.

To improve the performance of a maximum power point tracking system, a maximum power point tracking system with improved efficiency may be required by reducing the power loss that occurs in the process of transferring the electrical energy generated by the energy harvesting element.

### SUMMARY

Embodiments of the present disclosure provide a maximum power point tracking (MPPT) system and its operating method having improved power, cost, and area efficiency.

According to an embodiment of the present disclosure, a maximum power point tracking (MPPT) system include an energy harvesting element, a switching circuit that samples an open circuit voltage of the energy harvesting element as a sampling voltage in an open state, receives an input voltage from the energy harvesting element through an input node in a short-circuit state, and adjusts the input voltage based on the sampling voltage, a converter circuit that receives the adjusted input voltage from the switching circuit, and converts the adjusted input voltage into an output voltage to output the output voltage to an output node, and an MPPT control circuit that outputs a first MPPT control signal and a second MPPT control signal for controlling the maximum power point tracking system to the converter circuit, and the first MPPT control signal and the second MPPT control signal are based on a clock signal and have logic values inverted from each other, and the converter circuit opens or shorts the switching circuit based on the first MPPT control signal and the second MPPT control signal.

According to an embodiment, the energy harvesting element may be implemented as one of a thermoelectric energy harvesting element, a piezoelectric energy harvesting element, an RF energy harvesting element, and a photoelectric energy harvesting element.

According to an embodiment, the MPPT control circuit may also output the first MPPT control signal and the second MPPT control signal to the switching circuit.

According to an embodiment, the switching circuit may adjust the input voltage such that a magnitude of the input voltage is half a magnitude of the open circuit voltage of the energy harvesting element, and may transmit the adjusted input voltage to the converter circuit.

According to an embodiment, the switching circuit may include a first switch connected between the input node and a first sampling node, a second switch connected between the first sampling node and a second sampling node, a third switch connected between the second sampling node and a ground node, a first sampling capacitor connected between the first sampling node and the ground node, a second sampling capacitor connected in parallel with the third switch between the second sampling node and the ground node, and an input capacitor connected between the input node and the ground node, and the first switch and the third switch may operate in response to the first MPPT control signal, and the second switch may operate in response to the second MPPT control signal.

According to an embodiment, the converter circuit may be implemented as one of a boost converter, a buck converter, and a buck-boost converter.

According to an embodiment, the converter circuit may include an inductor connected between the input node and the converting node, a PMOS transistor connected between the converting node and the output node, an NMOS transistor connected between the converting node and a ground node, and an output capacitor connected between the output node and the ground node, and the PMOS transistor may operate in response to the first MPPT control signal, and the NMOS transistor may operate in response to the second MPPT control signal.

According to an embodiment, when the first MPPT control signal is logical high and the second MPPT control signal is logical low, both the NMOS transistor and the PMOS transistor may be turned off, and the switching circuit may be in the open state.

According to an embodiment of the present disclosure, a method of operating a maximum power point tracking (MPPT) system includes opening, by a converter circuit, a switching circuit based on a first MPPT control signal and a second MPPT control signal received from an MPPT control circuit, sampling, by the switching circuit, an open circuit voltage of an energy harvesting element as a sampling voltage, short-circuiting, by the converter circuit, the switching circuit which is opened, based on the first MPPT control signal and the second MPPT control signal received from the MPPT control circuit, receiving, by the switching circuit, an input voltage from the energy harvesting element through an input node, adjusting, by the switching circuit, the input voltage based on the sampling voltage, and receiving, by the converter circuit, the adjusted input voltage and converting the adjusted input voltage into an output voltage so as to output to an output node, and the first MPPT control signal and the second MPPT control signal are based on a clock signal and have logic values inverted from each other.

According to an embodiment, the adjusting, by the switching circuit, of the input voltage based on the sampling voltage may include adjusting the input voltage such that a magnitude of the input voltage is half a magnitude of the open circuit voltage of the energy harvesting element.

According to an embodiment, the converter circuit may include an inductor connected between the input node and the converting node, a PMOS transistor connected between the converting node and the output node, an NMOS transistor connected between the converting node and a ground node, and an output capacitor connected between the output node and the ground node, and the PMOS transistor may operate in response to the first MPPT control signal, and the NMOS transistor may operate in response to the second MPPT control signal.

According to an embodiment, the opening, by the converter circuit, of the switching circuit based on the first MPPT control signal and the second MPPT control signal received from the MPPT control circuit, may include, when the first MPPT control signal is logical high and the second MPPT control signal is logical low, turning off both the NMOS transistor and the PMOS transistor and causing the switching circuit to be in an open state.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a maximum power point tracking (MPPT) system 10, according to an embodiment of the present disclosure.

FIG. 2 is a block diagram illustrating an energy harvesting element 100, according to an embodiment of the present disclosure.

FIG. 3 is a graph illustrating characteristics of a short circuit current ISC of a thermoelectric energy harvesting element TEG versus an open circuit voltage VOC of the thermoelectric energy harvesting element TEG with respect to temperature of the thermoelectric energy harvesting element TEG, according to an embodiment of the present disclosure.

FIG. 4 is a graph illustrating characteristics of an open circuit voltage VOC of a thermoelectric energy harvesting element TEG versus an output power PTEG of the thermoelectric energy harvesting element TEG with respect to temperature of the thermoelectric energy harvesting element TEG, according to an embodiment of the present disclosure.

FIG. 5 is a block diagram illustrating a switching circuit 300, according to an embodiment of the present disclosure.

FIG. 6 is a block diagram illustrating a converter circuit 400, according to an embodiment of the present disclosure.

FIG. 7 illustrates states of gate terminal voltages of a plurality of transistors included in the converter circuit 400 depending on a first MPPT control signal Φ1 and a second MPPT control signal Φ2.

FIG. 8 is flowchart illustrating a method of operating the maximum power point tracking (MPPT) system 10, according to an embodiment of the present disclosure.

### DETAILED DESCRIPTION

Hereinafter, embodiments of the present disclosure will be described in detail and clearly to such an extent that an ordinary one in the art easily implements the present disclosure.

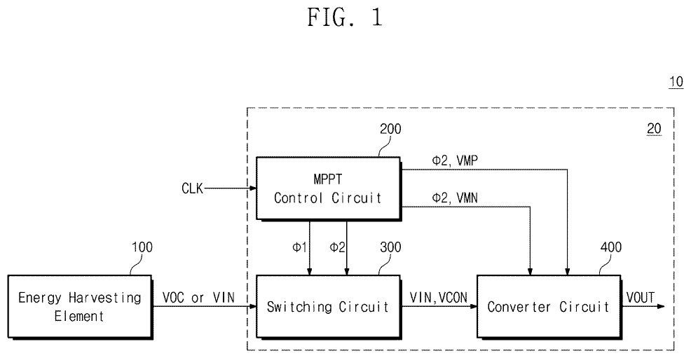

FIG. 1 is a block diagram illustrating a maximum power point tracking (MPPT) system 10, according to an embodiment of the present disclosure. Referring to FIG. 1, the maximum power point tracking system 10 may include an energy harvesting element 100 and a power management integrated circuit (PMIC) 20.

The energy harvesting element 100 may output electric energy by harvesting energy that is wasted in a surrounding environment. For example, the energy harvesting element 100 may transmit electric energy-based power as a voltage or a current to the power management integrated circuit 20. For example, the energy harvesting element 100 may transmit an open circuit voltage VOC or an input voltage VIN of the energy harvesting element 100 to the power management integrated circuit 20. The conditions for transmitting the open circuit voltage VOC of the energy harvesting element 100 and the conditions for transmitting the input voltage VIN will be described later with reference to a switching circuit 300.

The energy harvesting element 100 may harvest energy from energy sources such as heat, sunlight, and vibration in the surrounding environment, and convert the harvested energy into electric energy to transmit the power to the power management integrated circuit 20. In an embodiment of the present disclosure, the energy harvesting element 100 may be any one of a thermoelectric energy harvesting element (TEG: Thermo-Electric Generator), a piezoelectric energy harvesting element (Piezo-Electric Generator), an RF energy harvesting element (Radio Frequency Generator), and a photoelectric energy harvesting element (Solar Generator), but the present disclosure is not limited thereto.

The power management integrated circuit 20 may receive the open circuit voltage VOC or the input voltage VIN of the energy harvesting element 100 from the energy harvesting element 100, and may output an output voltage VOUT to an external device. In detail, the power management integrated circuit 20 may adjust the level of the received voltage, may convert the adjusted voltage into the output voltage VOUT, and may output the output voltage VOUT to an external device. For example, the external device may be a battery or a load, but the present disclosure is not limited thereto.

The power management integrated circuit 20 may include a maximum power point tracking control circuit 200, the switching circuit 300, and a converter circuit 400.

The maximum power point tracking control circuit 200 may generate a first MPPT control signal Φ1 and a second MPPT control signal Φ2 based on a clock signal CLK. The maximum power point tracking control circuit 200 may generate a PMOS transistor voltage VMP based on the first MPPT control signal Φ1. The maximum power point tracking control circuit 200 may generate an NMOS transistor voltage VMN based on the second MPPT control signal Φ2.

The maximum power point tracking control circuit 200 may output the first MPPT control signal Φ1 and the second MPPT control signal Φ2 to the switching circuit 300. The maximum power point tracking control circuit 200 may output the first MPPT control signal Φ1 together with the PMOS transistor voltage VMP to the converter circuit 400, and may output the second MPPT control signal Φ2 together with the NMOS transistor voltage VMN to the converter circuit 400. The first MPPT control signal Φ1 and the second MPPT control signal Φ2 may have logic values that are inverted from each other. The PMOS transistor voltage VMP and the NMOS transistor voltage VMN may have voltage levels that are logically inverted from each other. In addition, the first MPPT control signal Φ1 and the PMOS transistor voltage VMP may have the same logic value, and the second MPPT control signal Φ2 and the NMOS transistor voltage VMN may have the same logic value. For example, when the first MPPT control signal Φ1 is logical HIGH and the second MPPT control signal Φ2 is logical LOW, the PMOS transistor voltage VMP may have a logical high voltage level and the NMOS transistor voltage VMN may have a logical low voltage level. As another example, when the first MPPT control signal Φ1 is logical LOW and the second MPPT control signal Φ2 is logical HIGH, the PMOS transistor voltage VMP may have a logical low voltage level and the NMOS transistor voltage VMN may have a logical high voltage level.

The switching circuit 300 may include a plurality of switching devices. In response to the switching of the plurality of switching devices based on the first MPPT control signal Φ1 and the second MPPT control signal Φ2, the switching circuit 300 may perform a sampling operation or an adjustment operation. For example, when the first MPPT control signal Φ1 is logical HIGH and the second MPPT control signal Φ2 is logical LOW, the switching circuit 300 may perform a sampling operation. As another example, when the first MPPT control signal Φ1 is logical LOW and the second MPPT control signal Φ2 is logical HIGH, the switching circuit 300 may perform an adjustment operation.

When the switching circuit 300 performs a sampling operation, the switching circuit 300 may receive the open circuit voltage VOC of the energy harvesting element 100 from the energy harvesting element 100 and may sample the open circuit voltage VOC of the energy harvesting element 100 as a sampling voltage VS. When the switching circuit 300 performs the adjustment operation, the switching circuit 300 may adjust the sampling voltage VS to be half the magnitude of the existing sampling voltage VS, and the switching circuit 300 may receive the input voltage VIN from the energy harvesting element 100. In addition, when the switching circuit 300 performs the adjustment operation, a comparator 350 in the switching circuit 300 may adjust the input voltage VIN to have the same magnitude as the magnitude of the adjusted sampling voltage VS. In detail, when the switching circuit 300 performs the adjustment operation, the sampling voltage VS may be adjusted to be ½ of the magnitude of the open circuit voltage VOC of the energy harvesting element 100. In addition, the switching circuit 300 may adjust the input voltage VIN to be half the magnitude of the open circuit voltage VOC of the energy harvesting element 100 by the comparator 350 in the switching circuit 300.

When the switching circuit 300 performs the sampling operation, the switching circuit 300 may not output the input voltage VIN to the converter circuit 400. When the switching circuit 300 performs the adjustment operation, the switching circuit 300 may output the adjusted input voltage VIN to the converter circuit 400.

The converter circuit 400 may operate in response to the first MPPT control signal Φ1, the second MPPT control signal Φ2, the PMOS transistor voltage VMP, and the NMOS transistor voltage VMN. The converter circuit 400 may convert the adjusted input voltage VIN received from the switching circuit 300 into the output voltage VOUT, and may output the output voltage VOUT to an external device.

The converter circuit 400 may include a plurality of switching devices. In response to the switching of the plurality of switching devices based on the first MPPT control signal Φ1, the second MPPT control signal Φ2, the PMOS transistor voltage VMP, and the NMOS transistor voltage VMN, the switching circuit 300 may be in an open state or a short-circuit state. That is, the switching of the plurality of switching elements based on the first MPPT control signal Φ1, the second MPPT control signal Φ2, the PMOS transistor voltage VMP, and the NMOS transistor voltage VMN of the converter circuit 400 may control an opening or a short-circuiting of the switching circuit 300.

For example, when a plurality of switching devices are turned off based on the first MPPT control signal Φ1, the second MPPT control signal Φ2, the PMOS transistor voltage VMP, and the NMOS transistor voltage VMN, the switching circuit 300 may be in an open state. When the switching circuit 300 is in the open state, the switching circuit 300 may perform a sampling operation. For example, when a plurality of switching devices are turned on based on the first MPPT control signal Φ1, the second MPPT control signal Φ2, the PMOS transistor voltage VMP, and the NMOS transistor voltage VMN, the switching circuit 300 may be in a short-circuit state. When the switching circuit 300 is in the short-circuit state, the switching circuit 300 may perform an adjustment operation.

When the switching circuit 300 is in an open state, the converter circuit 400 does not receive the input voltage VIN from the switching circuit 300, and therefore may not output the output voltage VOUT. When the switching circuit 300 is in the short-circuit state, the converter circuit 400 receives the adjusted input voltage VIN from the switching circuit 300, and therefore may output the output voltage VOUT.

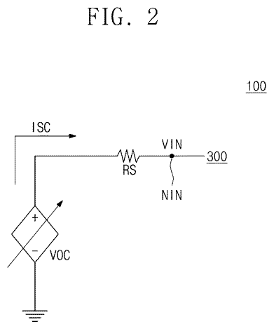

FIG. 2 is a block diagram illustrating the energy harvesting element 100, according to an embodiment of the present disclosure. Referring to FIG. 2, the energy harvesting element 100 may include an internal voltage source and an internal resistance RS.

The energy harvesting element 100 may be modeled as the internal voltage source and the internal resistance RS that output the open circuit voltage VOC and a short circuit current ISC by harvesting energy from the surrounding environment.

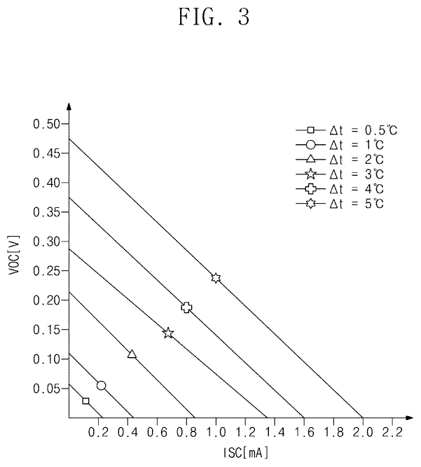

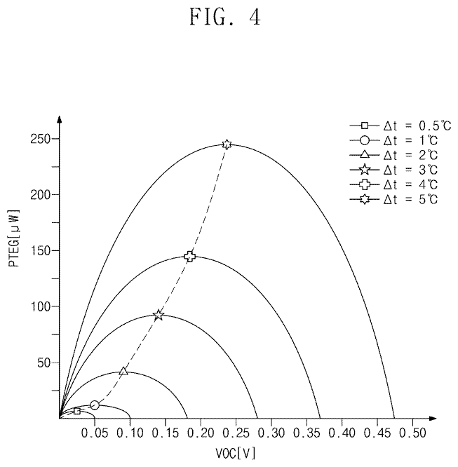

FIG. 3 is a graph illustrating characteristics of the short circuit current ISC of a thermoelectric energy harvesting element TEG versus the open circuit voltage VOC of the thermoelectric energy harvesting element TEG with respect to temperature of the thermoelectric energy harvesting element TEG, according to an embodiment of the present disclosure. FIG. 4 is a graph illustrating characteristics of the open circuit voltage VOC of a thermoelectric energy harvesting element TEG versus an output power PTEG of the thermoelectric energy harvesting element TEG with respect to temperature of the thermoelectric energy harvesting element TEG, according to an embodiment of the present disclosure.

Referring to FIGS. 2, 3, and 4, in an embodiment of the present disclosure, the energy harvesting element 100 is implemented as the thermoelectric energy harvesting element TEG, but the present disclosure is not limited thereto.

Depending on the type of the energy harvesting element 100, characteristics with respect to the short circuit current ISC of the energy harvesting element 100 versus the open circuit voltage VOC of the energy harvesting element 100 may be determined. Depending on the type of the energy harvesting element 100, the conditions for supplying maximum power to an external device may be determined.

A horizontal axis of the graph of FIG. 3 may indicate the short circuit current ISC of the thermoelectric energy harvesting element TEG, and a vertical axis may indicate the open circuit voltage VOC of the thermoelectric energy harvesting element TEG.

Referring to the graph of FIG. 3, the short circuit current ISC of the thermoelectric energy harvesting element TEG may be inversely proportional to the open circuit voltage VOC of the thermoelectric energy harvesting element TEG. The open circuit voltage VOC of the thermoelectric energy harvesting element TEG may increase as the temperature of the thermoelectric energy harvesting element TEG increases.

Referring to Equations 1 to 3 below, when an internal impedance (or the internal resistance RS) of the thermoelectric energy harvesting element TEG is the same as an input impedance of the power management integrated circuit 20, the maximum power may be obtained from the thermoelectric energy harvesting element TEG. In other words, the thermoelectric energy harvesting element TEG may output the maximum power when matching is achieved between the internal impedance (or the internal resistance RS) and the input impedance. A loss may occur between the power based on the open circuit voltage VOC of the thermoelectric energy harvesting element TEG and the power based on the input voltage VIN of the power management integrated circuit 20 by the difference between the internal impedance (or the internal resistance RS) of the thermoelectric energy harvesting element TEG and the input impedance of the power management integrated circuit 20.

$$P = VIN \cdot IIN = \frac{VIN \cdot ( VOC - VIN )}{RS} [ W ] \qquad [ Equation 1 ]$$

In Equation 1, power “P” is the power transmitted to the power management integrated circuit 20, and an input current IIN is the current input to the power management integrated circuit 20. The power “P” may be expressed as the product of the input voltage VIN and the input current IIN of the power management integrated circuit 20. The input current IIN may also be expressed as a relationship between the input voltage VIN, the open circuit voltage VOC, and the internal resistance RS.

$$\frac{\partial P}{\partial VIN} {\vert}_{max} = \frac{VOC - 2 VIN}{RS} [ W ] \qquad [ Equation 2 ]$$

$$VIN {\vert}_{max} = \frac{VOC}{2} [ V ] and {P}_{max} = \frac{{VOC}^{2}}{4 RS} [ W ] \qquad [ Equation 3 ]$$

In Equation 3, Pmax is a maximum power. In Equations 2 and 3, the condition of the input voltage VIN for obtaining the maximum power from the thermoelectric energy harvesting element TEG may be expressed. To find the condition for obtaining the maximum power in Equation 2, each side of Equation 1 may be differentiated with respect to the input voltage VIN, and the condition for having a pole may be obtained. In Equation 3, when the magnitude of the input voltage VIN corresponds to ½ of the magnitude of the open circuit voltage VOC, the maximum power may be transferred from the thermoelectric energy harvesting element TEG to the power management integrated circuit 20.

A horizontal axis of the graph of FIG. 4 may indicate the open circuit voltage VOC of the thermoelectric energy harvesting element TEG, and a vertical axis may indicate the output power PTEG of the thermoelectric energy harvesting element TEG.

Referring to the graph of FIG. 4, when the magnitude of the input voltage VIN corresponds to half of the magnitude of the open circuit voltage VOC of the thermoelectric energy harvesting element TEG, it may be confirmed that the maximum power is transmitted by matching the internal impedance (or the internal resistance RS) and the input impedance. To obtain the maximum power from the energy harvesting element 100, a maximum power point tracking technique may be applied.

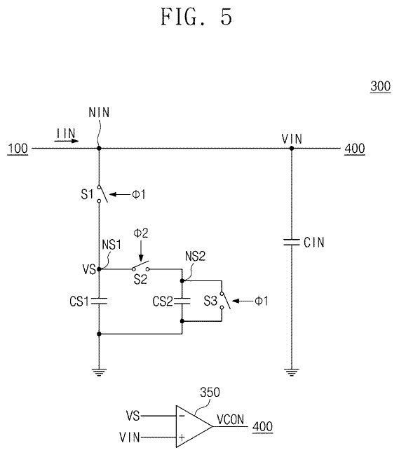

FIG. 5 is a block diagram illustrating the switching circuit 300, according to an embodiment of the present disclosure. Referring to FIG. 5, the switching circuit 300 may include a first switch S1, a second switch S2, a third switch S3, a first sampling capacitor CS1, a second sampling capacitor CS2, an input capacitor CIN, and the comparator 350.

The switching circuit 300 may sample the open circuit voltage VOC of the energy harvesting element 100. The switching circuit 300 may adjust the input voltage VIN received through an input node NIN and may transmit the adjusted input voltage VIN to the converter circuit 400.

Each of the first switch S1, the second switch S2, and the third switch S3 may be one of a plurality of switching devices of the switching circuit 300. The first switch S1 may be connected between the input node NIN and a first sampling node NS1. The second switch S2 may be connected between the first sampling node NS1 and a second sampling node NS2. The third switch S3 may be connected between the second sampling node NS2 and a ground node. The first sampling capacitor CS1 may be connected in parallel with the second switch S2 and the third switch S3 between the first sampling node NS1 and the ground node. The second sampling capacitor CS2 may be connected in parallel with the third switch S3 between the second sampling node NS2 and the ground node. The comparator 350 may have an inverting terminal connected to the first sampling node NS1, a non-inverting terminal connected to the input node NIN, and an output terminal connected to the converter circuit 400.

The switching circuit 300 of the typical maximum power point tracking system 10 may include an open control switch that controls the switching circuit 300 to be in an open state or a short-circuit state. The switching circuit 300 of the present disclosure may not include an open control switch included in the switching circuit 300 of the typical maximum power point tracking system 10.

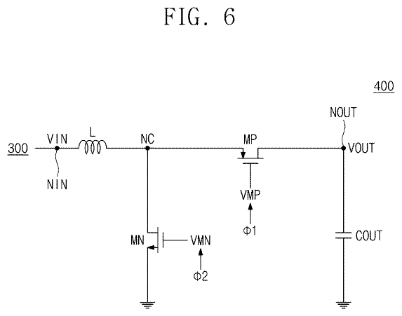

FIG. 6 is a block diagram illustrating the converter circuit 400, according to an embodiment of the present disclosure. Referring to FIG. 6, the converter circuit 400 may include an inductor “L”, a PMOS transistor MP, an NMOS transistor MN, and an output capacitor COUT.

The converter circuit 400 may control the switching circuit 300 to be in an open state or a short-circuit state. The converter circuit 400 may convert the adjusted input voltage VIN received from the switching circuit 300 into the output voltage VOUT, and may transmit the converted output voltage VOUT to an external device.

The inductor “L” may be connected between the input node NIN and a converting node NC. Each of the PMOS transistor MP and the NMOS transistor MN may be one of a plurality of switching devices of the converter circuit 400. The PMOS transistor MP may be connected between the converting node NC and an output node NOUT. The NMOS transistor MN may be connected between the converting node NC and the ground node. The output capacitor COUT may be connected between the output node NOUT and the ground node.

Referring to FIGS. 5 and 6, the first switch S1 and the third switch S3 may operate in response to the first MPPT control signal Φ1, and the second switch S2 may operate in response to the second MPPT control signal Φ2. In addition, the PMOS transistor MP may operate in response to the first MPPT control signal Φ1 and the PMOS transistor voltage VMP based on the first MPPT control signal 1, and the NMOS transistor MN may operate in response to the second MPPT control signal Φ2 and the NMOS transistor voltage VMN based on the second MPPT control signal Φ2.

For example, when the first MPPT control signal Φ1 is logical HIGH and the second MPPT control signal Φ2 is logical LOW, both the PMOS transistor MP and the NMOS transistor MN may be turned off. In detail, when the first MPPT control signal Φ1 is logical HIGH and the second MPPT control signal Φ2 is logical LOW, the PMOS transistor voltage VMP having a logical high voltage level may be applied to the PMOS transistor MP, and the NMOS transistor voltage VMN having a logical low voltage level may be applied to the NMOS transistor MN. Accordingly, both the PMOS transistor MP and the NMOS transistor MN are turned off, and the converting node NC becomes a floating state, so that the switching circuit 300 may become an open state.

In addition, the first switch S1 and the third switch S3 in the switching circuit 300 that is in the open state are turned on, and the second switch S2 is turned off, so that the switching circuit 300 may perform a sampling operation. In detail, the first sampling capacitor CS1 may sample the open circuit voltage VOC of the energy harvesting element 100 as the sampling voltage VS. That is, when the sampling operation is performed, the magnitude of the sampling voltage VS may be the same as the magnitude of the open circuit voltage VOC of the energy harvesting element 100 (i.e., VS=VOC). In addition, when the switching circuit 300 is in the open state, the first sampling node NS1 and the input node NIN may be short-circuited to each other. Therefore, the input capacitor CIN may sample the open circuit voltage VOC of the energy harvesting element 100 as the input voltage VIN like the first sampling capacitor CS1. That is, when the sampling operation is performed, the magnitude of the input voltage VIN may be the same as the magnitude of the open circuit voltage VOC of the energy harvesting element 100 (i.e., VIN=VOC).

For example, when the first MPPT control signal Φ1 is logical LOW and the second MPPT control signal Φ2 is logical HIGH, both the PMOS transistor MP and the NMOS transistor MN may be turned on. In detail, when the first MPPT control signal Φ1 is logical LOW and the second MPPT control signal Φ2 is logical HIGH, the PMOS transistor voltage VMP having a logical low voltage level may be applied to the PMOS transistor MP, and the NMOS transistor voltage VMN having a logical high voltage level may be applied to the NMOS transistor MN. Therefore, both the PMOS transistor MP and the NMOS transistor MN may be turned on, and the switching circuit 300 may be in a short-circuit state.

In addition, the first switch S1 and the third switch S3 in the switching circuit 300 that is in a short-circuit state are turned off, and the second switch S2 is turned on, so that the switching circuit 300 may perform an adjustment operation. In detail, the sampling voltage VS may be adjusted to be ½ of the magnitude of the existing sampling voltage VS by the first sampling capacitor CS1 and the second sampling capacitor CS2 having the same capacity as the first sampling capacitor CS1. That is, when the adjustment operation is performed, the magnitude of the sampling voltage VS may be adjusted to be ½ of the magnitude of the open circuit voltage VOC of the energy harvesting element 100 (i.e., VS=VOC/2).

When the switching circuit 300 performs the adjustment operation, the comparator 350 may output an adjustment control voltage VCON corresponding to the result of comparing the magnitude of the adjusted sampling voltage VS with the magnitude of the input voltage VIN. Although not illustrated, the adjustment control voltage VCON is applied to the NMOS transistor MN of the converter circuit 400 to control the on-off duty ratio of the NMOS transistor MN, thereby maintaining the magnitude of the input voltage VIN to be the same as the magnitude of the adjusted sampling voltage VS. In detail, the adjustment control voltage VCON controls the on-off duty ratio of the NMOS transistor MN to determine the energy charge-discharge balance of the inductor “L” and the output capacitor COUT, thereby adjusting the magnitude of the input voltage VIN to be the same as the magnitude of the adjusted sampling voltage VS (i.e., VIN=VS=VOC/2). Therefore, the switching circuit 300 may transmit the adjusted input voltage VIN to the converter circuit 400.

When both the PMOS transistor MP and the NMOS transistor MN are turned on, the converter circuit 400 may receive the adjusted input voltage VIN from the switching circuit 300 and may convert the adjusted input voltage VIN into the output voltage VOUT. For example, the converter circuit 400 may include one or more of a buck converter, a boost converter, and a buck-boost converter, but this is an example and the present disclosure is not limited thereto.

For example, the converter circuit 400 may increase or decrease the output voltage VOUT by controlling the duty ratio of the converter circuit 400 based on the control of the maximum power point tracking control circuit 200. For example, the converter circuit 400 may increase the output voltage VOUT when the output voltage VOUT is less than a target voltage, and may decrease the output voltage VOUT when the output voltage VOUT is greater than the target voltage. In this case, the target voltage may be set to have a voltage level required by an external device (e.g., a battery, a load, etc.) connected to the output node NOUT.

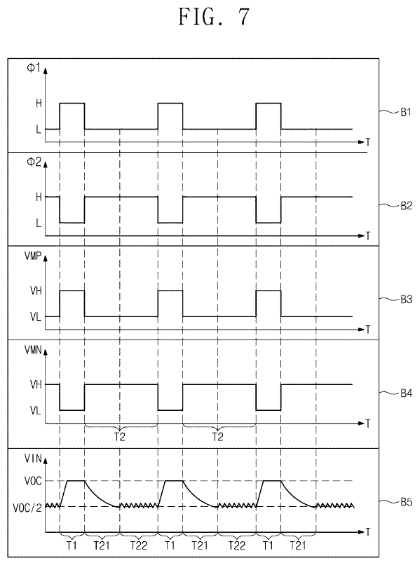

FIG. 7 illustrates states of gate terminal voltages of a plurality of transistors included in the converter circuit 400 depending on the first MPPT control signal 1 and the second MPPT control signal Φ2. For example, FIG. 7 illustrates voltage levels of the PMOS transistor voltage VMP and the NMOS transistor voltage VMN according to the first MPPT control signal Φ1 and the second MPPT control signal Φ2, and a voltage level of the input voltage VIN. A first box B1 illustrates a state of the first MPPT control signal Φ1. A second box B2 illustrates a state of the second MPPT control signal Φ2. A third box B3 illustrates a voltage level of the PMOS transistor voltage VMP. A fourth box B4 illustrates a voltage level of the NMOS transistor voltage VMN. A fifth box B5 illustrates a voltage level of the input voltage VIN. In FIG. 7, a horizontal axis indicates time “T”, a vertical axis of each of the first box B1 and the second box B2 indicates a state, and a vertical axis of each of the third box B3, the fourth box B4, and the fifth box B5 indicates a voltage level.

Referring to FIG. 7, the voltage levels of the PMOS transistor MP, the NMOS transistor MN, and the input voltage VIN may be repeatedly changed in response to the first MPPT control signal Φ1 and the second MPPT control signal Φ2. For example, a first period T1 may be shorter than the second period T2. In FIG. 7, each of the first period T1 and the second period T2 is illustrated as appearing repeatedly with a uniform period, but the present disclosure is not limited thereto. For example, depending on the design method of the maximum power point tracking system 10, when a change occurs in the external environment of the energy harvesting element 100, the maximum power point tracking system 10 may be configured to enter the first period T1 from the second period T2.

The relationship between the logic values of the first MPPT control signal Φ1, the second MPPT control signal Φ2, the PMOS transistor voltage VMP, and the NMOS transistor voltage VMN is described above with reference to the maximum power point tracking control circuit 200 of FIG. 1, and therefore, an additional description will be omitted to avoid redundancy.

In the first period T1, the converter circuit 400 of the maximum power point tracking system 10 may open the switching circuit 300. In the first period T1, the switching circuit 300 may sample the input voltage VIN as the open circuit voltage VOC of the energy harvesting element 100. After entering the first period T1, when the charging of the first sampling capacitor CS1 and the input capacitor CIN in the switching circuit 300 is completed, the sampling operation of the switching circuit 300 may be completed.

In the second period T2, the converter circuit 400 of the maximum power point tracking system 10 may short-circuit the switching circuit 300. The second period T2 may include a first sub-period T21 and a second sub-period T22. In the first sub-period T21, the switching circuit 300 may adjust the input voltage VIN to be half the magnitude of the open circuit voltage VOC of the energy harvesting element 100. In the second sub-period T22, the switching circuit 300 may transmit the adjusted input voltage VIN to the converter circuit 400.

In the first sub-period T21, the switching circuit 300 may adjust the sampling voltage VS to be half the magnitude of the open circuit voltage VOC of the energy harvesting element 100, and the comparator 350 may adjust the input voltage VIN to be equal to the magnitude of the adjusted sampling voltage VS. That is, in the first sub-period T21, the switching circuit 300 may be performing an adjustment operation. Therefore, in the first sub-period T21, the magnitude of the input voltage VIN may be different from half the magnitude of the open circuit voltage VOC of the energy harvesting element 100.

Therefore, in the first sub-period T21, when the power switching circuit 300 transmits the power received from the energy harvesting element 100 to the converter circuit 400, power loss may occur. Although not illustrated, the power loss occurring in the first sub-period T21 may be less than the power loss occurring in the typical maximum power point tracking system 10. For example, the typical maximum power point tracking system 10 may further include an open control switch, and the power loss may occur due to the open control switch. For example, the power loss occurring in the first sub-period T21 may be less than the power loss occurring in the typical maximum power point tracking system 10 by the power loss occurring due to the open control switch.

In the second sub-period T22, the adjustment operation of the switching circuit 300 may be completed. That is, the magnitude of the input voltage VIN may be maintained at ½ of the magnitude of the open circuit voltage VOC of the energy harvesting element 100. Therefore, in the second sub-period T22, the switching circuit 300 may transmit the maximum power to the converter circuit 400.

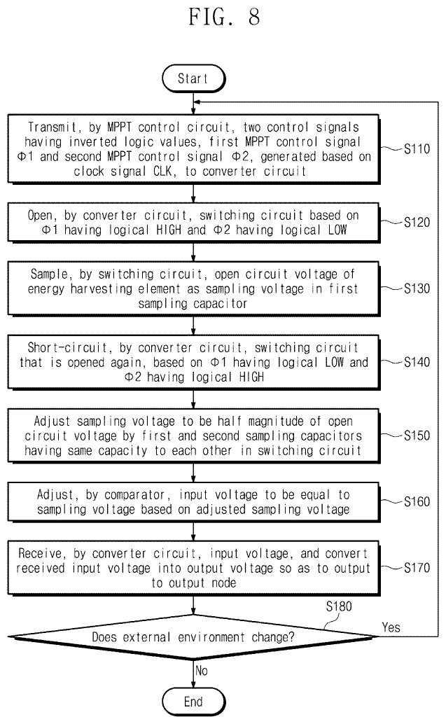

FIG. 8 is flowchart illustrating a method of operating the maximum power point tracking (MPPT) system 10, according to an embodiment of the present disclosure. Referring to FIG. 8, in operation S110, the maximum power point tracking control circuit 200 may transmit two control signals having inverted logic values, the first MPPT control signal Φ1 and the second MPPT control signal Φ2, generated based on the clock signal CLK, to the converter circuit 400.

In operation S120, when the first MPPT control signal Φ1 is logical HIGH and the second MPPT control signal Φ2 is logical LOW, the converter circuit 400 may open the switching circuit 300.

In operation S130, the switching circuit 300 that is in the open state may sample the open circuit voltage VOC of the energy harvesting element 100 as the sampling voltage VS in the first sampling capacitor CS1.

In operation S140, when the first MPPT control signal Φ1 is logical LOW and the second MPPT control signal Φ2 is logical HIGH, the converter circuit 400 may short-circuit the switching circuit 300 that is opened again.

In operation S150, the switching circuit 300 may adjust the sampling voltage VS to be half the magnitude of the open circuit voltage VOC of the energy harvesting element 100 by the first sampling capacitor CS1 and the second sampling capacitor CS2 having the same capacity to each other.

In operation S160, the comparator 350 may adjust the input voltage VIN to be equal to the adjusted sampling voltage VS based on the adjusted sampling voltage VS.

In operation S170, the converter circuit 400 may convert the input voltage VIN received from the switching circuit 300 into the output voltage VOUT and may output the output voltage VOUT to the output node NOUT.

In operation S180, the maximum power point tracking system 10 may determine whether a change occurs in the external environment of the energy harvesting element 100. When the change occurs in the external environment, the maximum power point tracking system 10 may return to operation S110 and repeat the above-described process. When the change does not occur in the external environment, the maximum power point tracking system 10 may terminate the operation.

According to an embodiment of the present disclosure, the maximum power point tracking (MPPT) system is provided in which a converter circuit performs the function of an open control switch that opens a circuit to sample an open circuit voltage of an energy harvesting element, instead of the open control switch. Accordingly, the maximum power point tracking system is provided in which power loss occurring in the open control switch is reduced by eliminating the open control switch, which is a passive device, and the component cost of the open control switch and the board area efficiency due to the open control switch are improved.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A maximum power point tracking (MPPT) system comprising:
an energy harvesting element;
a switching circuit configured to sample an open circuit voltage of the energy harvesting element as a sampling voltage in an open state, to receive an input voltage from the energy harvesting element through an input node, and to adjust the input voltage based on the sampling voltage in a short-circuit state;
a converter circuit configured to receive the adjusted input voltage from the switching circuit, and to convert the adjusted input voltage into an output voltage to output the output voltage to an output node; and
an MPPT control circuit configured to output a first MPPT control signal and a second MPPT control signal for controlling the maximum power point tracking system to the converter circuit, and
wherein the first MPPT control signal and the second MPPT control signal are based on a clock signal and have logic values inverted from each other, and
wherein the converter circuit is configured to open or short-circuit the switching circuit based on the first MPPT control signal and the second MPPT control signal.

2. The MPPT system of claim 1, wherein the energy harvesting element is implemented as one of a thermoelectric energy harvesting element, a piezoelectric energy harvesting element, an RF energy harvesting element, and a photoelectric energy harvesting element.

3. The MPPT system of claim 1, wherein the MPPT control circuit is configured to further output the first MPPT control signal and the second MPPT control signal to the switching circuit.

4. The MPPT system of claim 3, wherein the switching circuit is configured to adjust the input voltage such that a magnitude of the input voltage is half a magnitude of the open circuit voltage of the energy harvesting element, and to transmit the adjusted input voltage to the converter circuit.

5. The MPPT system of claim 4, wherein the switching circuit includes:
a first switch connected between the input node and a first sampling node;
a second switch connected between the first sampling node and a second sampling node;
a third switch connected between the second sampling node and a ground node;
a first sampling capacitor connected between the first sampling node and the ground node;
a second sampling capacitor connected in parallel with the third switch between the second sampling node and the ground node; and
an input capacitor connected between the input node and the ground node, and
wherein the first switch and the third switch are configured to operate in response to the first MPPT control signal, and the second switch is configured to operate in response to the second MPPT control signal.

6. The MPPT system of claim 1, wherein the converter circuit is implemented as one of a boost converter, a buck converter, and a buck-boost converter.

7. The MPPT system of claim 1, wherein the converter circuit includes:
an inductor connected between the input node and the converting node;
a PMOS transistor connected between the converting node and the output node;
an NMOS transistor connected between the converting node and a ground node; and
an output capacitor connected between the output node and the ground node, and
wherein the PMOS transistor is configured to operate in response to the first MPPT control signal, and the NMOS transistor is configured to operate in response to the second MPPT control signal.

8. The MPPT system of claim 7, wherein, when the first MPPT control signal is logical high and the second MPPT control signal is logical low, both the NMOS transistor and the PMOS transistor are turned off, and the switching circuit is in the open state.

9. A method of operating a maximum power point tracking (MPPT) system, the method comprising:
opening, by a converter circuit, a switching circuit based on a first MPPT control signal and a second MPPT control signal received from an MPPT control circuit;
sampling, by the switching circuit, an open circuit voltage of an energy harvesting element as a sampling voltage;
short-circuiting, by the converter circuit, the switching circuit, which is opened, based on the first MPPT control signal and the second MPPT control signal received from the MPPT control circuit;
receiving, by the switching circuit, an input voltage from the energy harvesting element through an input node;
adjusting, by the switching circuit, the input voltage based on the sampling voltage; and
receiving, by the converter circuit, the adjusted input voltage and converting the adjusted input voltage into an output voltage so as to output to an output node, and
wherein the first MPPT control signal and the second MPPT control signal are based on a clock signal and have logic values inverted from each other.

10. The method of claim 9, wherein the adjusting, by the switching circuit, of the input voltage based on the sampling voltage includes adjusting the input voltage such that a magnitude of the input voltage is half a magnitude of the open circuit voltage of the energy harvesting element.

11. The method of claim 9, wherein the converter circuit includes:
an inductor connected between the input node and the converting node;
a PMOS transistor connected between the converting node and the output node;
an NMOS transistor connected between the converting node and a ground node; and
an output capacitor connected between the output node and the ground node, and
wherein the PMOS transistor is configured to operate in response to the first MPPT control signal, and the NMOS transistor is configured to operate in response to the second MPPT control signal.

12. The method of claim 11, wherein the opening, by the converter circuit, of the switching circuit based on the first MPPT control signal and the second MPPT control signal received from the MPPT control circuit, includes, when the first MPPT control signal is logical high and the second MPPT control signal is logical low, turning off both the NMOS transistor and the PMOS transistor and causing the switching circuit to be in an open state.
